(19) United States
(12) Patent Application Publication
(10) Pub. No.: US 2022/0367966 A1
(43) Pub. Date: Nov. 17, 2022

(54) DEGASSING CHANNEL, BATTERY ASSEMBLY, AND MOTOR VEHICLE

(71) Applicant: AUDI AG, Ingolstadt (DE)

(72) Inventors: Tim HAEMMERLE, Bad Rappenau (DE); Thomas MILDE, Wüstenrot (DE); Markus SANDFORT, Neuburg a d Donau (DE); Martin SCHUESSLER, Koesching (DE); Markus THURMEIER, Adlkofen (DE); Jan-Philipp WEBERPALS, Absattt (DE)

(73) Assignee: AUDI AG, Ingolstadt (DE)

(21) Appl. No.: 17/712,351

(22) Filed: Apr. 4, 2022

(30) Foreign Application Priority Data
May 11, 2021 (DE) 102021112231.7

(51) Int. Cl. H01M 50/342; H01M 10/625; H01M 10/613; H01M 50/367

(52) U.S. Cl. CPC H01M 50/3425; H01M 10/625; H01M 10/613; H01M 50/367; H01M 2220/20

(57) ABSTRACT

A degassing channel for a battery in a motor vehicle designed to be arranged on a cell pack of the battery, which cell pack includes at least one battery cell, which has a releasable cell-degassing opening. The degassing channel has a first channel wall with a releasable wall opening that is assigned only to the cell-degassing opening, which wall opening can be released by a gas pressure of a gas escaping from the assigned cell-degassing opening when the degassing channel is arranged on the cell pack, so that the escaping gas can be directed through the released wall opening into an interior of the degassing channel.

### FIELD

The invention relates to a degassing channel for a battery in a motor vehicle, the degassing channel being designed to be arranged on a cell pack of the battery, which cell pack comprises at least one battery cell, which comprises a releasable cell-degassing opening. The invention also relates to a battery assembly and a motor vehicle.

### BACKGROUND

Battery cells for motor vehicle batteries, in particular high-voltage batteries, often have predeterminable degassing openings in order to allow gases to escape from the battery cell in the event of excess pressure within such a battery cell, for example due to strong gas development within the battery cell as part of a thermal event, without the battery cell exploding uncontrollably. A battery cell with such a releasable degassing opening, which is designed with a bursting element, is described in DE 10 2016 212 450 A1, for example.

Furthermore, DE 10 2017 218 752 A1 also describes a traction battery of a motor vehicle with several battery cells which are accommodated in the battery housing. Furthermore, a cover plate is provided for covering the battery housing, which closes off the receiving space of the battery housing from the surrounding area. The battery cells also have cover sides, facing the cover device, with respective degassing elements, from which hot gases produced in the battery cells can escape from the relevant battery cells into the receiving space of the battery housing. In this case, these degassing openings face an area of the covering device which has a higher heat resistance there than in other areas.

Such hot gases escaping from battery cells are thus generally directed into the receiving area of the battery housing. In order to enable venting from such a battery housing, it can have a corresponding valve or some other releasable opening, as is described, for example, in EP 2 244 318 Bl.

Accordingly, the free space inside a battery housing is used as a degassing channel for directing such hot gases out of the battery. As a result, battery cells that are still intact can disadvantageously heat up excessively and then also experience thermal runaway, which also increases the risk of a battery fire.

### SUMMARY

The object of the present invention is to provide a degassing channel, a battery assembly, and a motor vehicle which enable the most efficient and safest possible discharge of a hot gas escaping from a battery cell of a high-voltage battery, in particular in the event of a thermal runaway of this battery cell.

In this case, a degassing channel according to the invention for a battery cell in a motor vehicle is designed to be arranged on a cell pack of the battery, which cell pack comprises at least one battery cell, which comprises a releasable cell-degassing opening. The degassing channel has a first channel wall with a releasable wall opening that is assigned only to the cell-degassing opening, which wall opening can be released by a gas pressure of a gas escaping from the assigned degassing opening when the degassing channel is arranged on the cell pack, so that the escaping gas can be directed through the releasable wall opening into an interior of the degassing channel.

The gas escaping from a battery cell therefore first penetrates the releasable wall opening of the degassing channel in order to reach an interior of the degassing channel. Accordingly, the interior of the degassing channel can advantageously be separated from the rest of the interior, for example of a battery housing of the battery, the at least one cell pack with the at least one battery cell being accommodated in the battery housing. This advantageously makes it possible to keep hot gases escaping from battery cells away from other battery cells much more efficiently and thus to provide significantly better thermal decoupling. Above all, this thermal decoupling is enormously facilitated by the fact that the wall opening in the first channel wall, which wall opening is assigned to the relevant cell-degassing opening, is closed in the normal, intended operating state of the at least one battery cell, i.e. without this battery cell outgassing, the releasable degassing opening of which is assigned to the releasable wall opening, and in particular the wall opening is only released when this battery cell outgasses. Outgassing of a battery cell in the context of the present invention is to be understood in particular as the escape of hot gases from a battery cell, in particular as part of a thermal event, i.e. a thermal runaway of such a battery cell. In this case, outgassing can also be understood to mean only such an escape of hot gases as part of a thermal runaway of a battery cell. In the event of a thermal event, initially only a single battery cell in a high-voltage battery is affected. Over the course of time, without countermeasures, the thermal event spreads from this battery cell due to the heat generation from this battery cell, whereby neighboring battery cells also experience thermal runaway. In conventional battery systems, this spread is accelerated primarily by the hot gases escaping from the affected battery cells. The present invention can now advantageously be used to ensure that, for example, a particular releasable wall opening which is assigned to a non-outgassing and still intact battery cell or the cell-degassing opening thereof is also not released if, for example, another battery cell of the battery is already outgassing. The gas from other battery cells flowing through the degassing channel can thus be kept away from battery cells that are still intact much more efficiently, since this gas cannot get through the relevant releasable wall openings of battery cells that are still intact, since they are still closed. The thermal propagation of the battery can thus be delayed much more efficiently. In addition, a much more efficient and targeted gas control can be provided by the degassing channel.

In the present case, a releasable wall opening is to be understood to mean in particular a wall opening that is not permanently open, but is normally closed. This opening can be designed, for example, to open starting at a predetermined minimum pressure. It is preferred that the releasable wall opening is assigned to the cell-degassing opening in such a way that it can only be releasable due to the gas pressure of the gas escaping from the assigned cell-degassing opening. Such a releasable wall opening, which will be explained in more detail later, can also be designed with a bursting membrane or the like, for example, like the cell-degassing openings.

In a very advantageous embodiment of the invention, the first channel wall represents a battery housing base, preferably a cooling base for cooling the cell pack. In other words, the first channel wall is part of the battery housing and in particular provides the housing base, via which a cooling connection to the at least one cell pack of the battery preferably also takes place. The cooling base can have, for example, one or more cooling channels through which a coolant, for example a water-glycol mixture, can flow. The releasable wall opening can accordingly be arranged in a region of this cooling base in which there is no cooling channel, for example. Hot gases escaping from battery cells can thus be discharged from the battery particularly efficiently and routed directly through the cooling base, between the cooling channels. Furthermore, it is preferred that the cooling base is arranged below the at least one cell pack of the battery with respect to an intended installation position of the degassing channel and in particular with respect to the battery in the motor vehicle. The cooling base thus defines a housing lower side for a battery housing of the battery. The discharge of hot gases from the battery downwards has the great advantage that hot gases can be directed away from the passenger compartment of the motor vehicle in a targeted manner. The background to this is that a high-voltage battery in a motor vehicle is typically arranged in the underbody region, i.e. below a passenger compartment of the motor vehicle. In addition, directing the hot gases downwards enables a particularly fast and efficient discharge from the entire motor vehicle. Heating of other motor vehicle components, in particular such as the vehicle floor, can thus be avoided in a particularly efficient manner, or at least the heating can be delayed or the extent can be greatly reduced.

In a further very advantageous embodiment of the invention, the degassing channel has a second channel wall opposite the first, which is provided by an underride guard. The degassing channel can therefore be limited at the top by the cooling base of the battery and at the bottom by the underride guard of the motor vehicle, for example with regard to its intended installation position in the motor vehicle. There is sufficient room in this intermediate space to efficiently direct hot gases to the outside, in particular out of the motor vehicle. A corresponding discharge point can be suitably selected, for example to the side, to the front, or to the rear of the motor vehicle. After passing through at least a portion of this intermediate space between the underride guard and the cooling base, the hot gases can also be directed into a further exhaust gas channel and guided out of the motor vehicle through this further exhaust channel at any point. Due to the fact that the hot gases are not routed directly out of the motor vehicle via the shortest route, but instead first pass through part of the intermediate space between the underride guard and the cooling base as well as an optional exhaust gas channel, there is the advantage that the gases are further slowed down and particle separation is achieved, which ultimately means that the gas finally exiting the vehicle is significantly cooler and less likely to spontaneously ignite. As a result, safety can be further increased.

Nevertheless, it is also conceivable that the degassing channel is not provided by the cooling base and the underride guard, but instead is arranged above the cell pack, for example, and is provided, for example, by a housing cover arranged on the top of the battery and the vehicle floor positioned above the battery. This also provides a suitable intermediate space to allow the hot gases to be discharged from the vehicle. Because of the greater distance from the passenger compartment, however, it is preferred to provide for the hot gases to be discharged downwards, i.e. through the cooling base and into the intermediate space between the cooling base and the underride guard.

Furthermore, it is preferred that the first channel wall has several releasable wall openings, with a respective releasable wall opening being assigned to precisely one releasable cell-degassing opening of several respective battery cells of the battery. A high-voltage battery typically has numerous battery cells. The degassing channel should then preferably be designed in such a way that it also has an assigned, releasable wall opening for each cell-degassing opening of a respective battery cell. The assignment consists in particular in the fact that the hot gas escaping from the relevant assigned cell-degassing opening causes the assigned wall opening to be released and gas to penetrate this finally released wall opening. The releasable wall opening can therefore preferably only be released due to the gas pressure of the gas escaping from the assigned cell-degassing opening and not due to the gas pressure of other gases which may escape from other battery cells and the cell-degassing openings thereof. In this way, a particularly advantageous gradual, controlled opening can be provided.

In a further advantageous embodiment of the invention, the first channel wall has a material weakening in the region of the releasable wall opening to provide a predetermined breaking point for releasing the wall opening, which predetermined breaking point is designed in particular as an engraving on a side of the first channel wall that faces toward or faces away from the second channel wall, and which in particular is provided along a fully closed or non-closed line, which is at least partially angular and/or round and/or elliptical. The design of the channel wall with a material weakening in the region of the releasable wall opening, in particular in the form of an engraving, which can have any shape, is particularly simple and inexpensive in order to provide a predetermined breaking point that only opens, for example, starting from a certain minimum pressure, which is reached when the cell of the assigned cell-degassing opening degasses.

A material weakening in the form of an engraving can be introduced in a simple manner using a laser, for example. Such an engraving can also be arranged both on the side facing toward and the side facing away from the cell pack and correspondingly on the side facing toward or facing away from the second channel wall, such as the underride guard. Engraving on both sides is also conceivable. The metal sheets providing the cooling base typically have a thickness of 0.8 millimeters to 1.6 millimeters. A material weakening, i.e. an indentation, in the form of an engraving with a depth of between 0.1 millimeters and 0.3 millimeters has proven to be sufficient to ensure automatic release of the relevant wall opening in the event of thermal runaway of a battery cell and a resulting gas leak. Instead of making such an engraving directly in the cooling base or in the first channel wall, it can also be provided to first cut a corresponding hole into the first channel wall in order to provide such a releasable wall opening and to close this hole with a metal foil, for example through lamination. The first channel wall can be provided by an aluminum plate, for example, and the metal foil can be in the form of aluminum foil. However, forming the material weakening as an engraving has the advantage that a specific type of opening or release can also be provided in this way. For example, the engraving can be provided along a non-closed line, for example extending in a U-shape. If the opening were to be released, the channel wall would tear open in a U-shape along this line. However, the torn part of the channel wall would not detach completely from the remaining area of the channel wall, but would remain attached thereto, since the tearing does not occur along a closed line. This protruding wall part can accordingly provide targeted gas control or also a certain shielding, for example in a specific flow direction. When the releasable wall opening is torn open, the protruding part can, for example, also come to rest with an open, protruding end on the underride guard and thereby be bent or shaped in a curve, for example, and thus enable targeted gas control of the gas entering this intermediate area. This provides numerous other options for gas control. In particular, it is also conceivable that, for example, a targeted gas flow control can be provided depending on the position of the cells in the battery housing or the position of the cells in relation to the overall vehicle.

Therefore, a further advantageous embodiment of the invention is represented when the first channel wall has a first releasable wall opening, which is assigned to a first cell-degassing opening of a first battery cell, and has a second releasable wall opening, which is assigned to a second cell-degassing opening of a second battery cell, in which the material weakening in the region of the first releasable wall opening is designed differently than the material weakening in the region of the second releasable wall opening, so that when the first wall opening is released, an assigned, first gas control property is provided by the released first wall opening, which differs from a second gas control property, which is provided by the second wall opening in the event of release of the second wall opening. As already described above, a specific way of releasing the releasable wall opening can be provided in a targeted manner, for example by the type of formation of the engraving, and consequently also a specific gas control property can be provided, in particular with regard to the direction of the gas control. The engraving is therefore preferably located on the battery housing base and can be designed in any shape, for example round, square, elliptical or partial, to enable controlled opening and to direct the gas flow in a targeted manner, for example depending on the position of the cell in the battery housing. In other words, depending on the position of the cell in the vehicle, the structure can be opened differently in the event of a burst, and the gas flow will be directed separately. In this way, a corresponding gas control can be provided for each battery cell depending on its position within the battery and/or the motor vehicle. For example, gases escaping from battery cells in a first, e.g. left, half of the battery can be directed to a gas channel situated on a first, e.g. left, side, through the intermediate space between the cooling channel and the underride guard, and the gases escaping from battery cells in a second, e.g. right, side of the battery can be guided, in a targeted manner, to a gas channel arranged on a second, e.g. right, side. In this case, left and right can refer, for example, to a vehicle longitudinal direction of the motor vehicle, in which the degassing channel or the battery assembly described below is used.

Furthermore, the invention also relates to a battery assembly with a degassing channel according to the invention or one of the embodiments thereof. Furthermore, the battery assembly has a battery with at least one cell pack, which comprises at least one battery cell that has a releasable cell-degassing opening, the degassing channel being arranged on the cell pack in such a way that the releasable wall opening of the first channel wall is arranged opposite the assigned cell-degassing opening.

The battery can be designed in particular as a high-voltage battery for an electric or hybrid vehicle. A cell pack can generally define a cell group that comprises at least one battery cell. However, such a cell group preferably comprises several battery cells. Such a cell pack can also be provided in the form of a cell module with several battery cells which are connected to one another via a support structure. The battery cells of a battery module can also be arranged in a battery module housing, for example. In this case, it is preferred that the battery comprises several battery cells, in particular numerous battery cells. These can be in the form of prismatic battery cells, round cells, or pouch cells, for example. In the context of the present invention, however, the battery cells are preferably designed as prismatic battery cells. Furthermore, the battery cells can be formed, for example, as lithium-ion cells. The cell-degassing opening of such a battery cell is closed during normal operation of the battery cell. For example, the releasable cell-degassing opening can also be designed with a bursting membrane. Such a bursting membrane can be provided, for example, as a thin metal foil, for example aluminum foil, which closes an opening in the cell housing. With the pressure inside the battery cell reaches a corresponding level, the metal foil is destroyed or torn, thereby releasing the opening in the cell housing. Furthermore, it is advantageous if the dimensions of the releasable wall opening assigned to a respective cell-degassing opening are matched to the cell-degassing opening and can be designed, for example, the same size or slightly larger than the assigned cell-degassing opening. A respective wall opening is preferably at most as wide as the thickness of a corresponding battery cell. In other words, the respective edge openings should not directly adjoin one another, but should be spaced apart from one another. This is beneficial for the thermal decoupling.

In a further advantageous embodiment of the invention, the battery cell has a first side with two cell pole connections and a second side opposite the first side, on which the cell-degassing opening is arranged. In other words, the cell-degassing opening of a respective battery cell is preferably arranged on a lower side of the relevant battery cell, while the cell pole connections, on the other hand, are arranged on an opposite, upper side of the battery cell. This also has several advantages. On the one hand, this makes it possible to direct gases escaping from the battery cell downwards through a cooling base into the interior of the degassing channel. The cooling base is particularly easy to attach to a side of the battery cells on which no cell poles are arranged. These usually represent the lower side of the battery cells. At the same time, this advantageously also makes it possible to keep the hot gas flow escaping from a battery cell as far away as possible from the cell poles or cell pole taps and separate therefrom. Since hot gases escaping from battery cells contain electrically conductive particles, this can reduce the risk of voltage breakdown or arcing and a resulting gas ignition. As a result, the gas discharge can be made even safer.

In a further very advantageous embodiment of the invention, the degassing channel is arranged on the cell pack in such a way that the releasable wall opening of the first channel wall has a predetermined distance from the assigned cell-degassing opening to provide a free area between the releasable cell-degassing opening and the releasable wall opening. This is particularly advantageous precisely when the releasable cell-degassing opening is designed, for example, as a bursting membrane that opens at a predetermined pressure. The opening takes place outwards due to the force, i.e. outwards from the inside of the battery cell. A blockage can be prevented by the predetermined distance and the free space thereby provided between this releasable cell-degassing opening and the releasable wall opening. In other words, this ensures that the first channel wall does not impede the opening of the cell-degassing opening. In this case, even a small distance is sufficient to prevent such a blockage, for example in the range of between 1 and 5 millimeters, preferably between 1.5 millimeters and 2.5 millimeters, for example 2 millimeters.

In a further advantageous embodiment of the invention, a partition, in particular an O-ring, surrounding the wall opening and the assigned cell-degassing opening is arranged between the releasable wall opening and the assigned cell-degassing opening, which partition separates a free inner region between the cell-degassing opening and the wall opening from an outer region between the cell pack and the degassing channel, which is at least partially filled with a thermally conductive compound. Such a thermally conductive compound is used for the thermal connection of the battery cells to the cooling base. During the manufacture of the battery, this thermally conductive compound is placed between the cooling base and the battery cells in a free-flowing state, for example injected into the intermediate space between the battery cells and the cooling base or applied to the cooling base, and the cell packs are then placed on the thermally conductive compound and pressed into the surface. Regardless of the type of installation, such a partition, for example in the form of an O-ring, advantageously means that precisely this region between the cell-degassing openings and the assigned, releasable wall openings is kept free and thus no such thermally conductive compound can penetrate into this region. Such an O-ring can be provided, for example, in the form of a foam strip, rubber ring, or a similar element that prevents such a thermally conductive compound, also known as a gap filler, from penetrating into this free area that is to be kept free. It can thus advantageously be achieved that the gap filler does not fill this cavity or free space between the releasable wall opening and the releasable cell-degassing opening, which in turn can prevent a blocking effect when the releasable openings are gradually opened.

If, for example, no thermally conductive compound is used or introduced between the first channel wall and the cell pack, such a partition can also be dispensed with accordingly. This also applies in particular if a thermally conductive material that is at least initially non-flowable, for example a thermally conductive mat or the like, is used for the thermal connection.

Furthermore, the invention also relates to a motor vehicle having a battery assembly according to the invention or one of the embodiments thereof.

The motor vehicle according to the invention is preferably designed as an automobile, in particular as a passenger car or truck, or as a passenger bus or motorcycle.

The invention also comprises combinations of the features of the described embodiments. The invention also comprises implementations that each have a combination of the features of several of the described embodiments, provided that the embodiments were not described as mutually exclusive.

### BRIEF DESCRIPTION OF THE FIGURES

Exemplary embodiments of the invention are described hereinafter. The following is shown:

FIG. 1 a schematic illustration of a battery cell for a battery assembly according to an exemplary embodiment of the invention;

FIG. 2 a schematic illustration of a battery assembly with several battery cells and a channel wall of a degassing channel according to an exemplary embodiment of the invention;

FIG. 3 a schematic cross-sectional illustration of a battery assembly with a battery cell arranged on the degassing channel according to an exemplary embodiment of the invention;

FIG. 4 a schematic cross-sectional illustration of a detailed view of the connection point between the cell-degassing opening and the releasable wall opening according to an exemplary embodiment of the invention; and

FIG. 5 a schematic illustration of the time sequence during degassing of a battery cell according to an exemplary embodiment of the invention.

### DETAILED DESCRIPTION

The exemplary embodiments explained hereinafter are preferred embodiments of the invention. In the exemplary embodiments, the described components of the embodiments each represent individual features of the invention to be considered independently of one another, which features each also refine the invention independently of one another. Therefore, the disclosure is also intended to encompass combinations of the features of the embodiments other than those illustrated. Furthermore, the described embodiments can also be supplemented by further features of the invention previously described.

In the figures, the same reference numerals designate elements that have the same function.

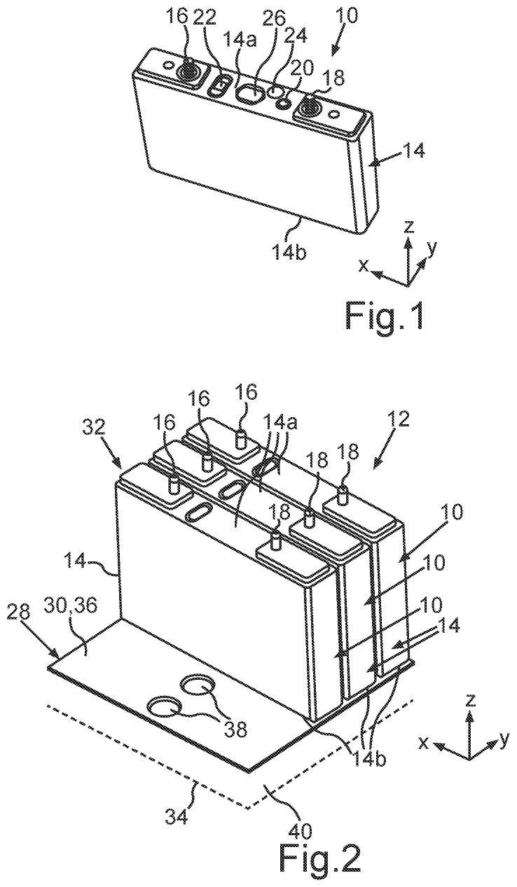

FIG. 1 shows a schematic and perspective illustration of a battery cell 10 for a battery assembly 12 according to an exemplary embodiment of the invention. Such an exemplary battery assembly 12 is shown in FIG. 2, for example. The battery cell 10 shown as an example in FIG. 1 is designed as a prismatic battery cell and has a cell housing 14 which provides an upper side 14a and a lower side 14b of the battery cell 10. Two cell pole connections 16, 18 of the battery cell 10 are arranged on the upper side. One of these two cell pole connections 16, 18 is designed as a positive pole and the other as a negative pole. Moreover, additional components can also be arranged on the upper side 14a of the battery cell 10, such as a filling opening 20 for filling the cell housing 14 with an electrolyte during the manufacture of the battery cell 10, a data matrix code 22 which can be provided as a QR code, for example, and a thermochromatic sticker 24.

Furthermore, such a battery cell 10 has a releasable degassing opening 26. As shown in FIG. 1, this degassing opening can also be arranged on the upper side 14a of the battery cell 10; however, in the exemplary embodiments described below, it is arranged on the lower side 14b of the cell housing 14 instead. Such a degassing opening 26 can be provided, for example, with a bursting membrane that ruptures due to overpressure, which is provided, for example, by a thin metal foil that closes an opening in the cell housing 14.

In the case of conventional batteries, in particular high-voltage batteries for electric or hybrid vehicles, it is not possible to have direct hot gas control per cell, in particular not downwards. Instead, additional fire protection plates are usually used in the cover of the battery housing; however, they are very expensive and heavy so as to prevent runaway of a cell into the interior of the motor vehicle. However, the invention and the embodiments thereof now make it possible to provide significantly more efficient gas control.

To this end, FIG. 2 shows a schematic illustration of a battery assembly 12 with several battery cells 10. These battery cells 10 can in particular, as described for FIG. 1, be designed with the difference that now the cell-degassing openings 26 mentioned above are not arranged on the upper side 14a of a relevant cell housing 14, but instead are arranged on the opposite, lower side 14b. Correspondingly, these releasable cell-degassing openings 26 are not visible in the illustration, as in FIG. 2. Furthermore, the battery assembly 12 comprises a degassing channel 28, only part of which is shown in this example, namely a first channel wall 30, which faces the cell pack 32 provided by the several battery cells 10. The degassing channel 28 can be delimited by a second channel wall 34 on a side opposite this first channel wall 30, which in the present case is merely indicated by dashed lines. It is particularly advantageous if the first channel wall 30 is provided, for example, by a cooling base 36 of the battery housing of the battery, which comprises the cell pack 32, and the second channel wall 34 is provided by an underride guard of the motor vehicle. The degassing channel 28 can then advantageously have several releasable wall openings 38 on the first channel wall 30. In this case, each wall opening 38 is assigned to exactly one cell-degassing opening 26. There is also such a releasable wall opening 38 in the first channel wall 30 below each battery cell 10 in FIG. 2. Provision is also made for further battery cells 10 to be arranged above these respective releasable wall openings 38 shown in FIG. 2, which are not shown in FIG. 2 for clearer illustration of the releasable wall openings 38. These releasable wall openings 38 are normally closed and only open when the battery cell in question with the assigned cell-degassing opening 26 outgasses. The gas discharge then takes place through a gradual, controlled opening of these gas control structures provided by the releasable wall openings 38 in the battery housing base 36, which is preferably designed in such a way that there is no blockage with respect to the combination of cell 10 and housing base 36 and the free space located therebetween. The respective releasable wall openings 38 can also be provided as bursting openings, for example as described for the battery cell 10 in relation to the cell-degassing openings 26 thereof, or provided by a differently designed material weakening in the first channel wall 30, for example in the form of an engraving. If an overpressure occurs in a specific cell 10, its underside cell-degassing opening 26 opens first, as a result of which the gas produced in cell 10 can escape therefrom directly onto the assigned, releasable wall opening 38 of the first channel wall 30, which consequently also opens and thereby directs the escaping gas into the interior 40 of the degassing channel 28.

For better thermal decoupling, it is very advantageous that each cell 10 has its own assigned, releasable wall opening 38. Accordingly, the wall openings 38 preferably have a spacing, in particular in the y-direction, and a width which, in the y-direction, is at most as large as a thickness of the assigned cell 10 in the y-direction, for example 30 mm at most. The thickness of the cells 10 in the y-direction is less than a width of the cells 10 in the y-direction and a height of the cells 10 in the z-direction. Several cells 10 of the cell pack are arranged next to one another in the y-direction.

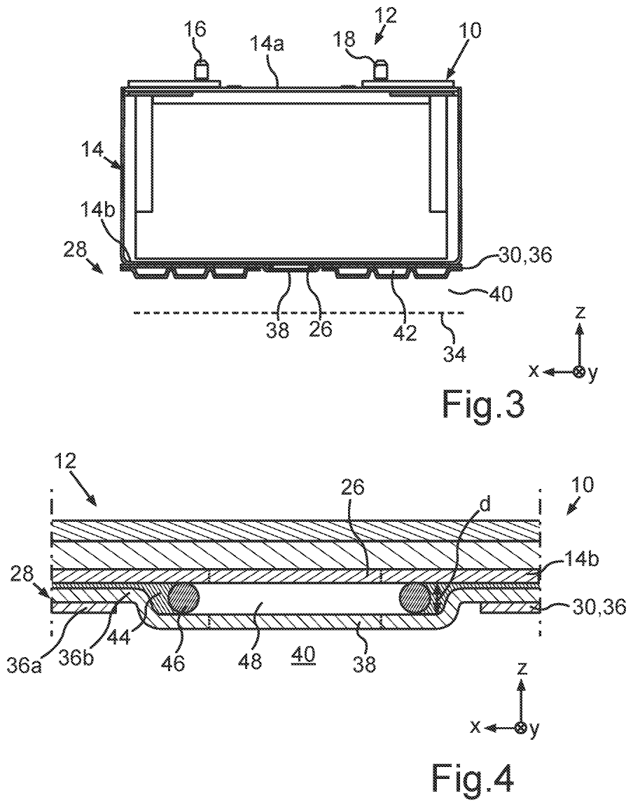

FIG. 3 shows a schematic cross-sectional illustration through a battery assembly 12 according to an exemplary embodiment of the invention. This cell assembly 12 in turn comprises a battery cell 10, which can be designed as described above, and a degassing channel 28, which can also be designed as described above. FIG. 4 again shows a detailed illustration of a section from FIG. 3 in the connection region for connecting the releasable cell-degassing opening 26 to the releasable wall opening 38. FIG. 3 also shows the first channel wall 30 preferably designed as a cooling base 36. In other words, the first channel wall 30 preferably provides a base of the battery housing, on which the battery cells 10 are arranged, and which at the same time provides cooling channels 42 through which a cooling medium can flow. Furthermore, in the present case, a respective battery cell 10 is connected to the cooling base 36 via a thermally conductive compound 44, also known as a gap filler. Such a thermally conductive compound 44 can make the heat dissipation from the battery cell 10 to the cooling base 36 more efficient during normal operation. The releasable wall opening 38 is arranged directly opposite the assigned, releasable cell-degassing opening 26 of the battery cell 10, as can be seen clearly in detail, particularly in FIG. 4. It is also advantageous if the releasable wall opening 38 has a definable minimum distance d from the releasable cell-degassing opening 26, which is preferably between 1 and 3 millimeters, for example 2 millimeters. This makes it possible to ensure that a blockage does not occur in the event of successive opening of the cell-degassing opening 26 and subsequently the releasable wall opening 38. Furthermore, in this example, a partition, in this example in the form of an O-ring 46, is arranged in the region between the cell-degassing opening 26 and the releasable wall opening 38. This O-ring 46 is round, corresponding to the releasable wall openings 38 in this example, and around the releasable wall opening 38 and the assigned cell-degassing opening 26, so that a free space 48 is created between the releasable wall opening 38 and the assigned, releasable cell-degassing opening 26. The O-ring 46 keeps this free space 48 free while the gap filler 44 is being filled during the manufacture of the battery. This therefore ensures that no gap filler compound 44 can get into this free space area 48 during production.

The cooling base 36 can be composed, for example, of a cooling plate 36a and a base plate 36b, between which the cooling channels 42 are formed and which can each be in the form of metal sheets, for example. The releasable wall opening 38 can then be formed accordingly in one of these metal sheets 36a, 36b, for example in the base plate 36b in this case.

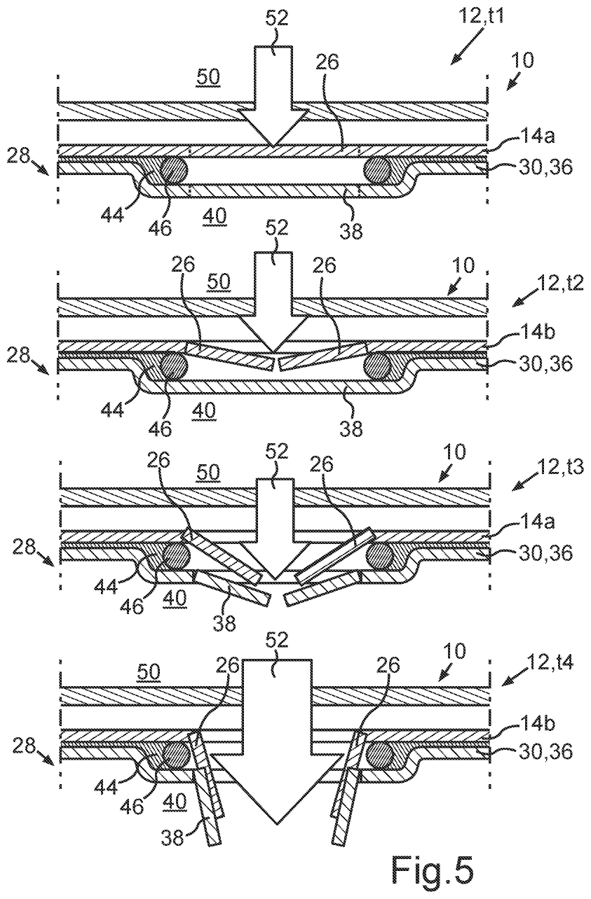

It is particularly advantageous here, for example, if this releasable wall opening 38 is provided, for example, by an engraving in the base 36 for a respective, assigned cell-degassing opening 26. This engraving opens up when the degassing pressure of the cells 10 increases and directs the gas flow between the base sheet 36 and the underride guard 34 to the outside in a targeted manner. As a result, the spreading to further cells 10 can be prevented or at least delayed by the improved thermal decoupling. This gradual, controlled opening will now be described in more detail with reference to FIG. 5.

To this end, FIG. 5 shows a time sequence of such an opening process in the event of outgassing of a battery cell 10. In this case, FIG. 5 shows the battery assembly 12 or the part thereof for four different points in time t1, t2, t3, t4, which is also illustrated as relates to FIG. 4. The battery assembly 12 can thus in turn be designed as previously described.

At the first point in time t1, both the cell-degassing opening 26 and the releasable wall opening 38 are still in an intact state. This means that both the cell-degassing opening 26 and the assigned, releasable wall opening 38 are still closed in this situation. Due to a thermal event in the cell 10, a gas 52 develops in the interior 50 of the battery cell 10, which leads to an increased gas pressure inside this battery cell 10. As shown at point in time t1, this increased gas pressure acts on the releasable cell-degassing opening 26 and, when a specific threshold value is exceeded, causes this cell-degassing opening 26 to open, as is the case at point in time t2. The gas stream 52 consequently flowing out of the cell 10 is then correspondingly directed directly onto the assigned, releasable wall opening 38, which consequently also opens, as is illustrated in FIG. 5 at point in time t3. Due to the ongoing gas flow 52, parts of the cell housing 14 as well as the channel wall 30 form outwards in the region of the respective cell-degassing opening 26 and wall opening 38, i.e. in the direction of the interior 40 of the degassing channel 28. This end state is shown in FIG. 5 at point in time t4. The gas flow 52 thus reaches the interior 40 of the degassing channel, which is provided by the intermediate space between the underride guard 34 and the cooling base 36 of the battery or the vehicle. In this intermediate space, the outflowing gas 52 can also be routed to an exhaust pipe or directly out of the vehicle in a targeted manner.

Overall, the examples show how an actively controllable degassing system can be provided by the invention, according to which a gas opening system is preferably integrated directly into the base. The base can be partially engraved under the cells. This engraving opens up when the degassing pressure of the cells increases and directs the gas flow between the base sheet and underride guard outwards in a targeted manner to prevent the spreading to other cells. This enables the hot gas to be discharged quickly and protects the occupants of the motor vehicle for a longer period of time. In addition, cost and weight savings can be achieved by dispensing with additional measures.

1. A degassing channel for a battery in a motor vehicle, wherein the degassing channel is designed to be arranged on a cell pack of the battery, which cell pack comprises at least one battery cell, which comprises a releasable cell-degassing opening, wherein the degassing channel has a first channel wall with a releasable wall opening that is assigned only to the cell-degassing opening, which wall opening can be released by a gas pressure of a gas escaping from the assigned cell-degassing opening when the degassing channel is arranged on the cell pack, so that the escaping gas can be directed through the released wall opening into an interior of the degassing channel.

2. The degassing channel according to claim 1, wherein the first channel wall represents a cooling base for cooling the cell pack.

3. The degassing channel according to claim 1, wherein the degassing channel has a second channel wall opposite the first, which is provided by an underride guard.

4. The degassing channel according to claim 1, wherein the first channel wall has a material weakening in the region of the releasable wall opening to provide a predetermined breaking point for releasing the wall opening, which predetermined breaking point is designed as an engraving on a side of the first channel wall that faces toward or faces away from the second channel wall, and which is provided along a fully closed or non-closed line, which is at least partially angular and/or round and/or elliptical.

5. The degassing channel according to claim 4, wherein the first channel wall has a first releasable wall opening, which is assigned to a first cell-degassing opening of a first battery cell, and has a second releasable wall opening, which is assigned to a second cell-degassing opening of a second battery cell, wherein the material weakening in the region of the first releasable wall opening is designed differently than the material weakening in the region of the second releasable wall opening, so that when the first wall opening is released, an assigned, first gas control property is provided by the released wall opening, which differs from a second gas control property, which is provided by the second, releasable wall opening in the event of release of the second wall opening.

6. A battery assembly with a degassing channel according to claim 1, wherein the battery assembly has a battery with at least one cell pack, which comprises at least one battery cell that has a releasable cell-degassing opening, wherein the degassing channel is arranged on the cell pack in such a way that the releasable wall opening of the first channel wall is arranged opposite the assigned cell-degassing opening.

7. The battery assembly according to claim 6, wherein the battery cell has a first side with two cell pole connections and a second side opposite the first side, on which the cell-degassing opening is arranged.

8. The battery assembly according to claim 6, wherein the degassing channel is arranged on the cell pack in such a way that the releasable wall opening of the first channel wall has a predetermined distance to the assigned, releasable cell-degassing opening to provide a free area between the releasable cell-degassing opening and the releasable wall opening.

9. The battery assembly according to claim 6, wherein a partition surrounding the releasable wall opening and the assigned, releasable cell-degassing opening is arranged between the releasable wall opening and the assigned, releasable cell-degassing opening, which partition separates a free inner region between the releasable cell-degassing opening and the releasable wall opening from an outer region between the cell pack and the degassing channel, which is at least partially filled with a thermally conductive compound.

10. A motor vehicle having a battery assembly according to claim 6.

11. The degassing channel according to claim 2, wherein the degassing channel has a second channel wall opposite the first, which is provided by an underride guard.

12. The degassing channel according to claim 2, wherein the first channel wall has a material weakening in the region of the releasable wall opening to provide a predetermined breaking point for releasing the wall opening, which predetermined breaking point is designed as an engraving on a side of the first channel wall that faces toward or faces away from the second channel wall, and which is provided along a fully closed or non-closed line, which is at least partially angular and/or round and/or elliptical.

13. The degassing channel according to claim 3, wherein the first channel wall has a material weakening in the region of the releasable wall opening to provide a predetermined breaking point for releasing the wall opening, which predetermined breaking point is designed as an engraving on a side of the first channel wall that faces toward or faces away from the second channel wall, and which is provided along a fully closed or non-closed line, which is at least partially angular and/or round and/or elliptical.

14. A battery assembly with a degassing channel according to claim 2, wherein the battery assembly has a battery with at least one cell pack, which comprises at least one battery cell that has a releasable cell-degassing opening, wherein the degassing channel is arranged on the cell pack in such a way that the releasable wall opening of the first channel wall is arranged opposite the assigned cell-degassing opening.

15. A battery assembly with a degassing channel according to claim 3, wherein the battery assembly has a battery with at least one cell pack, which comprises at least one battery cell that has a releasable cell-degassing opening, wherein the degassing channel is arranged on the cell pack in such a way that the releasable wall opening of the first channel wall is arranged opposite the assigned cell-degassing opening.

16. A battery assembly with a degassing channel according to claim 4, wherein the battery assembly has a battery with at least one cell pack, which comprises at least one battery cell that has a releasable cell-degassing opening, wherein the degassing channel is arranged on the cell pack in such a way that the releasable wall opening of the first channel wall is arranged opposite the assigned cell-degassing opening.

17. A battery assembly with a degassing channel according to claim 5, wherein the battery assembly has a battery with at least one cell pack, which comprises at least one battery cell that has a releasable cell-degassing opening, wherein the degassing channel is arranged on the cell pack in such a way that the releasable wall opening of the first channel wall is arranged opposite the assigned cell-degassing opening.

18. The battery assembly according to claim 7, wherein the degassing channel is arranged on the cell pack in such a way that the releasable wall opening of the first channel wall has a predetermined distance to the assigned, releasable cell-degassing opening to provide a free area between the releasable cell-degassing opening and the releasable wall opening.

19. The battery assembly according to claim 7, wherein a partition surrounding the releasable wall opening and the assigned, releasable cell-degassing opening is arranged between the releasable wall opening and the assigned, releasable cell-degassing opening, which partition separates a free inner region between the releasable cell-degassing opening and the releasable wall opening from an outer region between the cell pack and the degassing channel, which is at least partially filled with a thermally conductive compound.

20. The battery assembly according to claim 8, wherein a partition surrounding the releasable wall opening and the assigned, releasable cell-degassing opening is arranged between the releasable wall opening and the assigned, releasable cell-degassing opening, which partition separates a free inner region between the releasable cell-degassing opening and the releasable wall opening from an outer region between the cell pack and the degassing channel, which is at least partially filled with a thermally conductive compound.
